(19) United States
(12) Patent Application Publication
(10) Pub. No.: US 2009/0302191 A1
(43) Pub. Date: Dec. 10, 2009

(54) MOLDING DEVICE AND METHOD FOR MAKING MOLD CORE

(75) Inventors: HOU-YAO LIN, Tu-Cheng (TW); CHUN-KAI WANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/344,657

(22) Filed: Dec. 29, 2008

(30) Foreign Application Priority Data
Jun. 10, 2008 (CN) 200810302071.1

(51) Int. Cl. B29C 33/00

(52) U.S. Cl. 249/63; 29/592

(57) ABSTRACT

A molding device includes a mold and a mold core received in the mold. The mold has an insert receiving cavity defined therein and an inner surface in the insert receiving cavity. The mold core includes a core insert and a connection portion. The core insert has a molding surface defined at a first distal end thereof and a lateral surface. The lateral surface of the core insert contacts the inner surface in the insert receiving cavity. The connection portion has a distal end connected with an opposing second distal end of the core insert. The connection portion is received in the insert receiving cavity and spaced from the inner surface of the mold.

### BACKGROUND

1. Technical Field

The present invention relates generally to a molding device and a method for making a mold core.

2. Description of Related Art

With the development of industry, molding processes are widely used for manufacturing workpieces, for example, optical articles such as lenses and light guide plates. The molding processes are carried out by molding apparatuses.

The molding apparatus basically includes a mold having a cavity defined therein and a mold core received in the cavity. The mold core specially includes a base and a core insert integrally formed with the base. The mold has an inner surface in the cavity. When the mold core is assembled in the mold, the core insert should matingly contact with the inner surface of the mold. Therefore, after the core insert being formed by a rough machining process, a finish machining process is required to machine the core insert so that more area of the side face of the core insert could contact with the inner surface of the cavity. However, the entire side face of the core insert needs to be finish machined. It may be a waste of time and a lifetime of a cutter for machining the core insert may be shortened.

Therefore, a molding device and a method for making a mold core is desired to overcome the above shortcomings.

### BRIEF DESCRIPTION OF THE DRAWING

Many aspects of the present molding device and method for making a mold core can be better understood with reference to the following drawings. The components in the drawing are not necessarily drawn to scale, the emphasis instead being placed upon clearly illustrating the principles of the present mold core and method for making the same. Moreover, in the drawings, like reference numerals designate corresponding parts throughout the several views.

FIG. 1 is a schematic, isometric view of a mold core in accordance with a first embodiment.

FIG. 2 is a schematic, cross-sectional view of a molding device, and the molding device of FIG. 1.

FIG. 3 is a flow chart of a method for making the mold core in FIG. 1 in accordance with a second embodiment.

FIG. 4 is a schematic, isometric view of a half finished product of the mold core.

### DETAILED DESCRIPTION OF THE EMBODIMENTS

Embodiments of the present molding apparatus will now be described in detail below and with reference to the drawing.

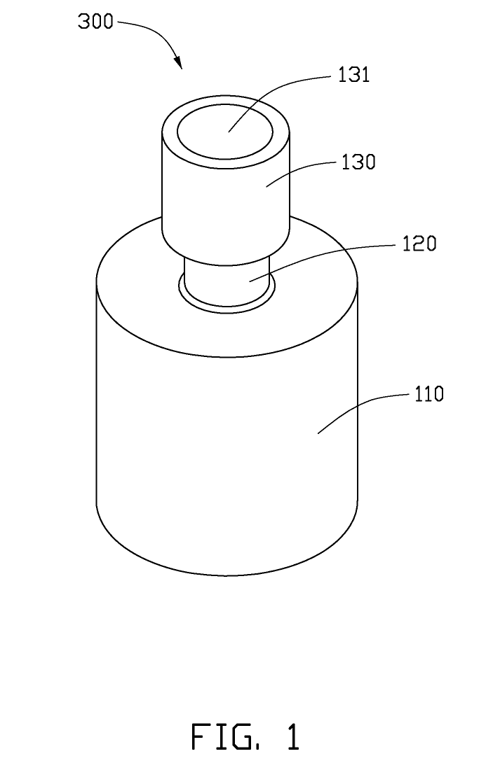

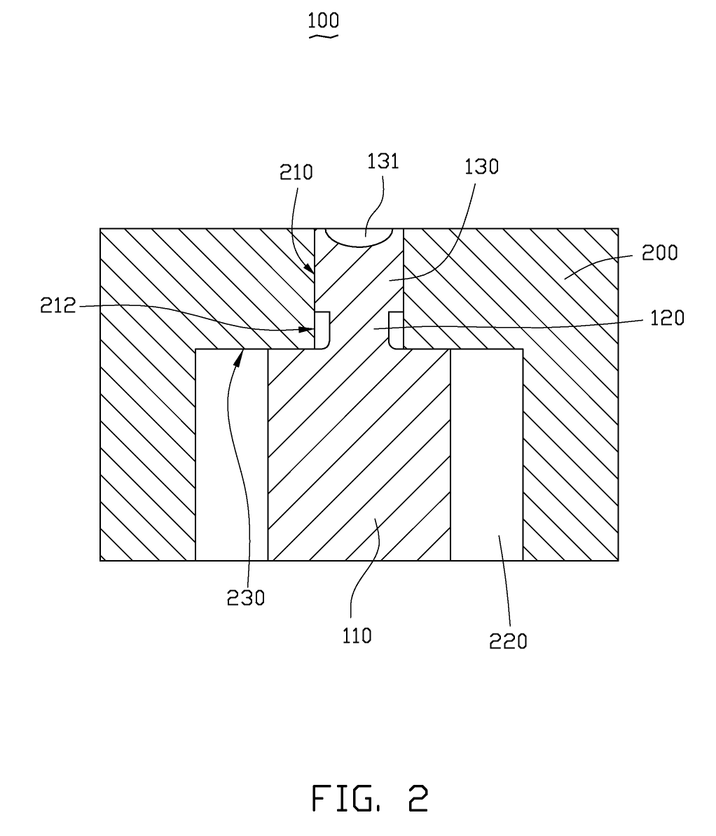

Referring to FIGS. 1 and 2, a molding device 100 is provided in accordance with a first exemplary embodiment. The molding device 100 includes a mold core 300 and a mold 200 for receiving the mold core 300. The mold core 300 includes a base 110, a core insert 130 and a connection portion 120 interconnected between the base 110 and the core insert 130. The connection portion 120 is formed on the base 1 10. In this embodiment, the base 110, the connection portion 120 and the core insert 130 each has a cylinder shape and are coaxial with each other. A diameter of the core insert 130 is greater than the diameter of the connection portion 120, and a diameter of the base 110 is greater than the diameter of the core insert 130. A molding surface 131 is defined in a distal end of the core insert 130.

The mold 200 has an insert receiving cavity 210 and a base receiving cavity 220 defined therein. The insert receiving cavity 210 is in communication with the base receiving cavity 2209 The insert receiving cavity 210 has a cylinder shape with a diameter substantially equal to the diameter of the core insert 130. The insert receiving cavity 210 is configured for receiving the core insert 130.

The base receiving cavity 220 is configured for receiving the base 110I Because the diameter of the base 110 is greater than the diameter of the core insert 130, a step surface 230 is formed on the mold 200 between the insert receiving cavity 210 and the base receiving cavity 220.

When the mold core 300 is assembled in the mold 200, the core insert 130 and the connection portion 120 are received in the insert receiving cavity 210 and the base 110 is received in the base receiving cavity 220. The base 110 contacts the step surface 230 of mold 200.

The mold 200 has an inner surface 212 (not labeled) in the insert receiving cavity 210. The inner surface 212 of the mold 200 and a lateral surface of the core insert 130 are treated by a finish machining method with a cutter, to achieve smoothness, thus both surfaces are smooth enough to closely contact each other. Preferably, a length of the core insert 130 is greater than a length of the connection portion 120 along a central of the core insert 130 to ensure that the core insert 130 firmly received in the mold 200.

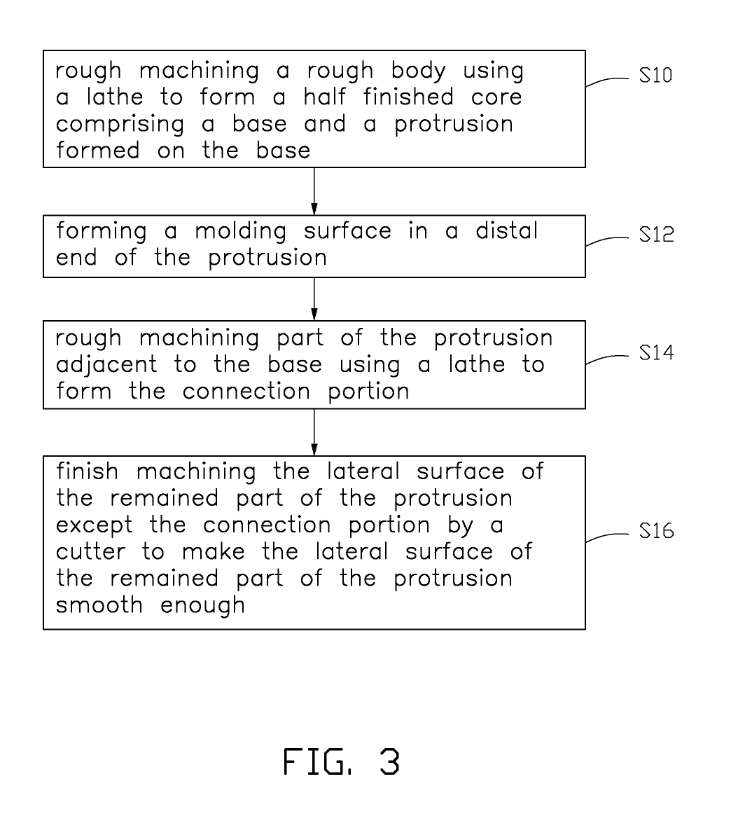

Referring to FIG. 3, a flow chart of a method for making the mold core 300 is shown in accordance with a second exemplary embodiment. The method is described in detail as follows.

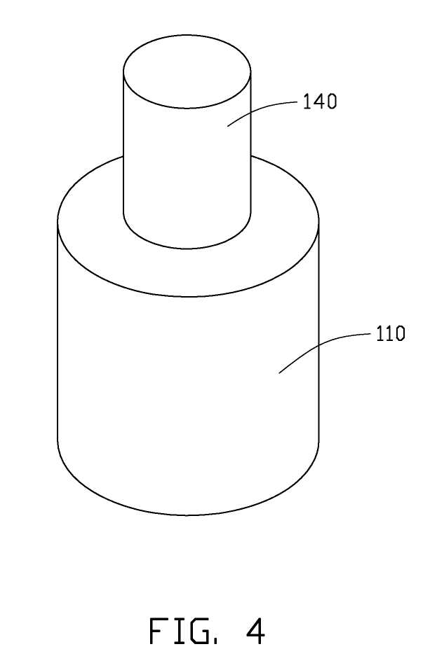

Referring to FIG. 4, in step S10, a rough body is rough machined using a lathe to form a half finished core comprising a base 110 and a protrusion 140 formed on the base 110. The protrusion 140 has a cylinder shape and has a diameter almost equal to the diameter of the core insert 130. In such case, the protrusion 140 has a rough lateral surface.

In step S12, the molding surface 131 is formed in a distal end of the protrusion 140. A method for forming the molding surface 131 may be a pressing method. In step S14, part of the protrusion 140 adjacent to the base 110 is rough machined using a lathe to form the connection portion 120.

In step S16, the lateral surface of the remained part of the protrusion 140 except the connection portion 120 is finish machined by a cutter to make the lateral surface of the remained part of the protrusion 140 smooth. Thus, a core inserter 130 with a smooth lateral surface is formed.

In this embodiment, there is no need to finish machining the lateral surface of the connection portion 120 because the lateral surface of the connection portion 120 and the lateral surface of the core insert 130 are spaced from each other. Therefore, it costs less time to finish machine the mold core 300, thus saving time and increasing the lifetime of the cutter.

It is understood that the above-described embodiment are intended to illustrate rather than limit the invention. Variations may be made to the embodiments and methods without departing from the spirit of the invention. Accordingly, it is 10 appropriate that the appended claims be construed broadly and in a manner consistent with the scope of the invention.

What is claimed is:

1. A molding device, comprising:
a mold having an insert receiving cavity defined therein and an inner surface in the insert receiving cavity; and
a mold core received in the mold, comprising
a core insert having a molding surface defined at a first distal end thereof, and a lateral surface, the lateral surface of the core insert contacting the inner surface in the insert receiving cavity; and
a connection portion having a distal end connected with an opposing second distal end of the core insert, the connection portion being received in the insert receiving cavity and spaced from the inner surface of the mold.

2. The molding device as claimed in claim 1, wherein the mold core further comprises a base connected with an opposite end of the connection portion to the core insert, the mold having a base receiving cavity in communication with the insert receiving cavity, the base being received in the base receiving cavity.

3. The molding device as claimed in claim 2, wherein the core insert and the connection portion each has a cylinder shape and are coaxial with each other, a diameter of the core insert being greater than a diameter of the connection portion, and the insert receiving cavity has a diameter substantially equal to the diameter of the core insert.

4. The molding device as claimed in claim 3, wherein the base has a cylinder shape and is coaxial with the core insert, a diameter of the base being greater than the diameter of the core insert, a step surface being formed between the insert receiving cavity and the base receiving cavity, the base contacting the step surface.

5. A method for making the core insert, comprising:
providing a mold core preform comprising a base and a protrusion formed on the base;
defining an annular groove in the protrusion; and
machining a lateral surface of the protrusion a smooth lateral surface of the protrusion.

6. The method as claimed in claim 5, further comprising a step of forming a molding surface in a distal end of the protrusion.
